(19) United States
(12) Patent Application Publication
(10) Pub. No.: US 2013/0264337 A1
(43) Pub. Date: Oct. 10, 2013

(54) COMBINATION MICROWAVE/WARMER AND OVEN

(71) Applicant: MAG AEROSPACE INDUSTRIES, INC., Carson, CA (US)

(72) Inventor: Thomas M. Lee, Coto de Caza, CA (US)

(21) Appl. No.: 13/803,819

(22) Filed: Mar. 14, 2013

Related U.S. Application Data
(60) Provisional application No. 61/615,521, filed on Mar. 26, 2012.

(51) Int. Cl. H05B 6/80

(52) U.S. Cl. CPC H05B 6/80
USPC 219/685; 219/680; 219/702

(57) ABSTRACT

Embodiments of the present invention relate generally to a combined microwave and warmer, provided in a single device. Such devices find particular use on-board passenger transport vehicles, such as aircraft, although they may be useful in any other instance when space and/or weight reduction is at a premium.

### CROSS REFERENCE TO RELATED APPLICATIONS

This application claims the benefit of U.S. Provisional Application Ser. No. 61/615,521, filed Mar. 26, 2012, titled “Combination Microwave/Bun Warmer,” the entire contents of which are hereby incorporated by reference.

### FIELD OF THE INVENTION

Embodiments of the present invention relate generally to a combined microwave and warmer, provided in a single device. Such devices find particular use on-board passenger transport vehicles, such as aircraft, although they may be useful in any other instance when space and/or weight reduction is at a premium.

### BACKGROUND

Aircraft galleys are different from traditional cooking kitchens, in that space is very limited and weight reduction is a high priority. Similar situations exist on private yachts, cruise ships, and other sea-going vessels, as well as motor homes, passenger trains, and other types of passenger transport vehicles. Nonetheless, there are instances when food preparation is necessary, and a high quality food product is expected. Microwave ovens cook and/or warm food very quickly. However, because they tend to absorb moisture, they are not the optimal warming device for bread or other items that may dry out quickly. Bun warmers or warming drawers deliver a low, consistent amount of heat to a food item, but are not intended to cook the items. Traditionally, these different devices have been provided as separate units. However, providing both a bun warmer and a microwave in an aircraft galley takes up valuable space. Additionally, providing two separate units adds to the overall weight of the aircraft, which is undesirable from a fuel cost standpoint. Accordingly, the present inventors have sought to provide solutions to these problems.

### BRIEF SUMMARY

Embodiments of the invention described herein thus provide a combined microwave and warmer/oven into one device. This design saves space, as well as reduces the overall weight of the galley components required to produce high quality meals. Certain embodiments provide air flow solutions that address the conversion between use of the device in microwave mode and switching to use of the device in warmer/oven mode. The combination microwave and warmer device has an inner cook cavity surrounded by side walls, a back wall, a top wall, a base, and a door. It also has a magnetron associated with the cook cavity that generates microwaves. Additionally, one or more heating elements are positioned along outer faces of one or more of the side walls, the back wall, the top wall, and/or the base. The magnetron may be activated for use of the device as a microwave oven in a first mode, and the one or more heating elements are activated for use of the device as a warmer in a second mode.

### BRIEF DESCRIPTION OF THE DRAWINGS

FIG. 1 shows a side perspective cut way view of one embodiment of a combination device.

FIG. 2 shows a front perspective cut away view of the device.

FIG. 3 shows a front perspective view of the device with the outer housing in place and the door open, illustrating the inner cavity.

FIG. 4 shows a schematic illustrating one potential placement of a heating element.

FIG. 5 shows a side perspective view of how warmers are currently positioned in bun warmers, but the same positions could be used in connection with the combination microwave embodiments described herein.

FIG. 6 shows a further view of the bun warmer of FIG. 5.

FIG. 7 shows a side plan view section of a combination device with a heating element and insulation in place.

FIG. 8 shows a front perspective view of a combination device with a keypad and display screen.

### DETAILED DESCRIPTION

Embodiments of the present invention provide a combination microwave/warmer device 10. The “warmer” feature of the device 10 may be used on low to medium settings for warming buns or other items, or the warmer features may be used on higher settings in order to deliver more heat and to convert the device into more of an oven capacity. One of the advantages of this device 10 is that it may be used in aircraft or other passenger transport vehicles or any other area where space is at a premium, but where both a microwave and a bun warmer (and/or a heating oven) are desired for use. For example, in an aircraft galley, it is often desirable to be able to heat meals in a microwave. However, using a microwave to heat bread may cause the bread to become hard, so aircraft galleys often also have a bun warmer installed as well. Providing these two devices in the galley takes up valuable space and adds weight considerations to the aircraft. The present inventors have sought to combine microwave capabilities with warming capabilities in a single device 10.

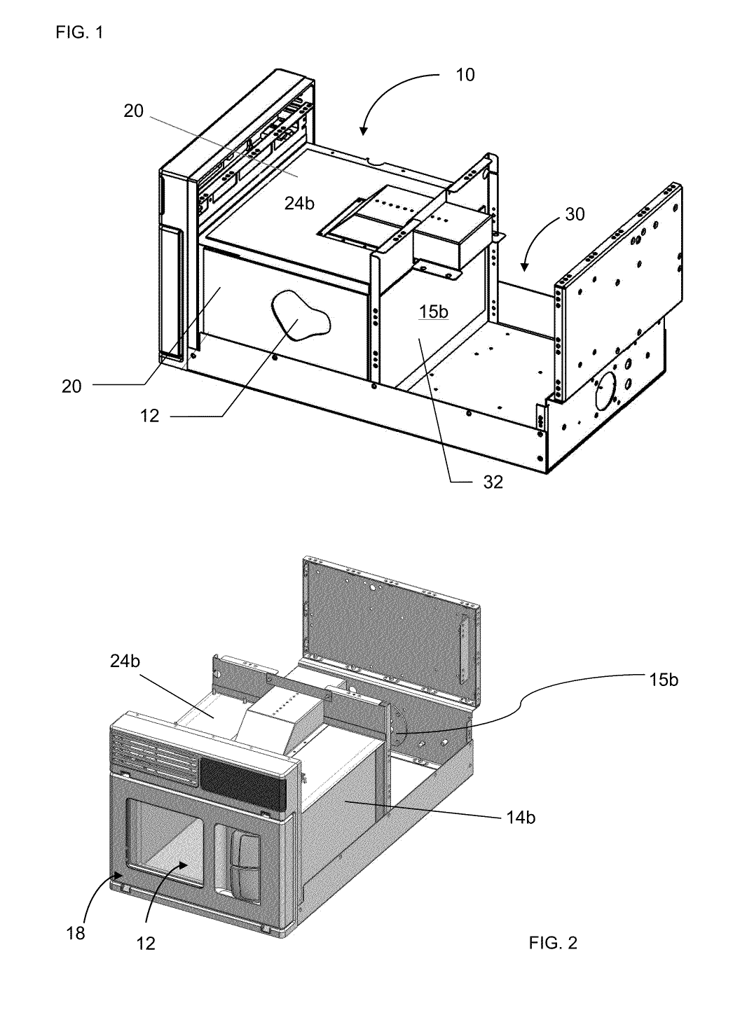

In the embodiment shown in FIGS. 1-3, the device 10 includes an inner cook cavity 12, which is generally a stainless steel cavity. The cavity 12 has inner side walls 14, generally formed as a stainless steel liner, along with an outer housing 16. A back wall 15, a top wall 24, and base 26 are also provided. These features may be formed as a stainless steel box or cube, as shown in the schematic of FIG. 4. The front of the device 10 is closed via a standard microwave oven and/or bun warmer door 18.

In addition to the magnetron and other components that are necessary for microwave oven operation of the device in a first mode (not shown for the sake of simplicity, but that would generally be housed in the back 30 area of the device 10), the device 10 also includes one or more heating elements 20 that are necessary for warming in a second mode. The heating elements 20 are used to radiate heat into the cook cavity 12 in order to warm bread. (It should be understood that the heating elements 20 may also be used at higher settings in order to radiate heat into the cook cavity 12 in order to deliver more heat, such as heat to warm or cook meals or other items. Although embodiments are described herein with respect to a bun warmer, certain embodiments of the invention are not intended to be so limited.) The heating elements 20 are generally positioned outside the inner cavity 12 of a traditional microwave oven device, so that the magnetron of the microwave will still work. However, when the magnetron is not in use, the heating pad elements 20 can be used to warm bread or other items contained inside the device. This combination saves weight and space, but still allows the two devices to still be used separately when necessary.

FIG. 1 illustrates a cut away view of a device 10, with the outer shell/housing 16 removed. This figure illustrates various locations where heating pad elements 20 or blankets may be attached. FIG. 2 shows a front view of the device 10 with the outer housing 16 removed in order to show the cook cavity 12. Each of the walls of the cavity 12 (e.g., side walls 14, back wall 15, and top wall) 24 has a first inner face (14a, 15a, and 24a) that faces into the inner cavity 12 area, as well as an outer face (14b, 15b, and 24b) that forms the outside portions of the cavity. The inner cavity is generally a stainless steel inner liner, which forms a polished cavity. The magnetron is outside this chamber and the microwaves are directed inside the inner cavity to heat the food in microwave mode when the microwave is activated.

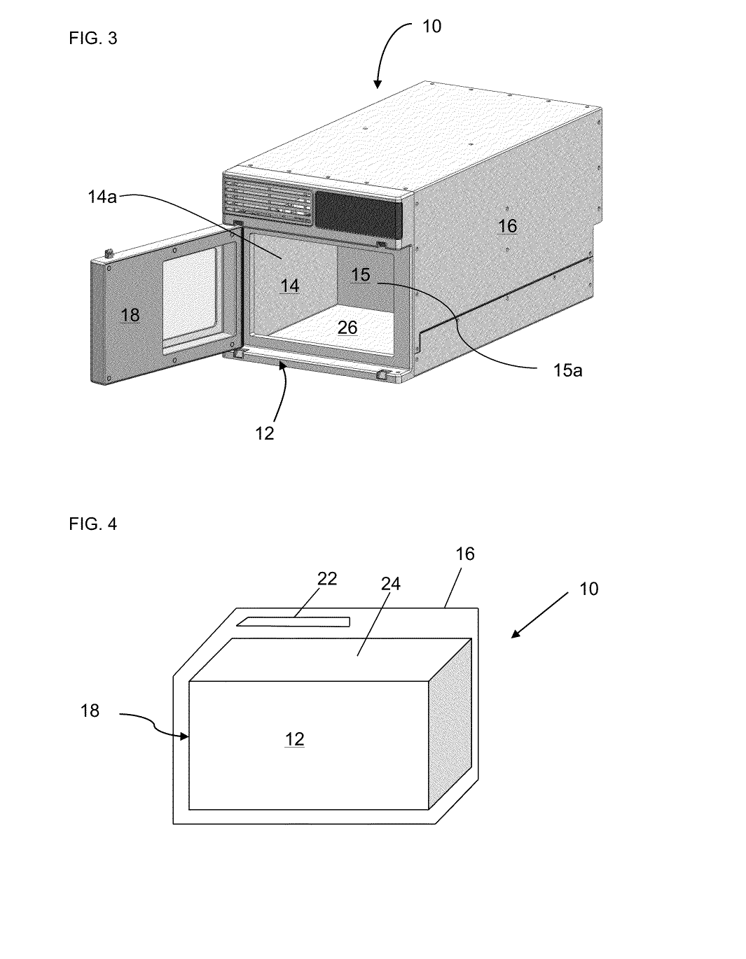

FIG. 2 illustrates the outer faces of the walls 14b, 15b, 24b. FIG. 3 shows a front view of the device 10 with the outer housing 16 in place and with the door 18 open. The inner faces 14a of the side walls 14 and the inner face 15a of the back wall 15 are shown. The base 26 of the cavity 12 is also shown.

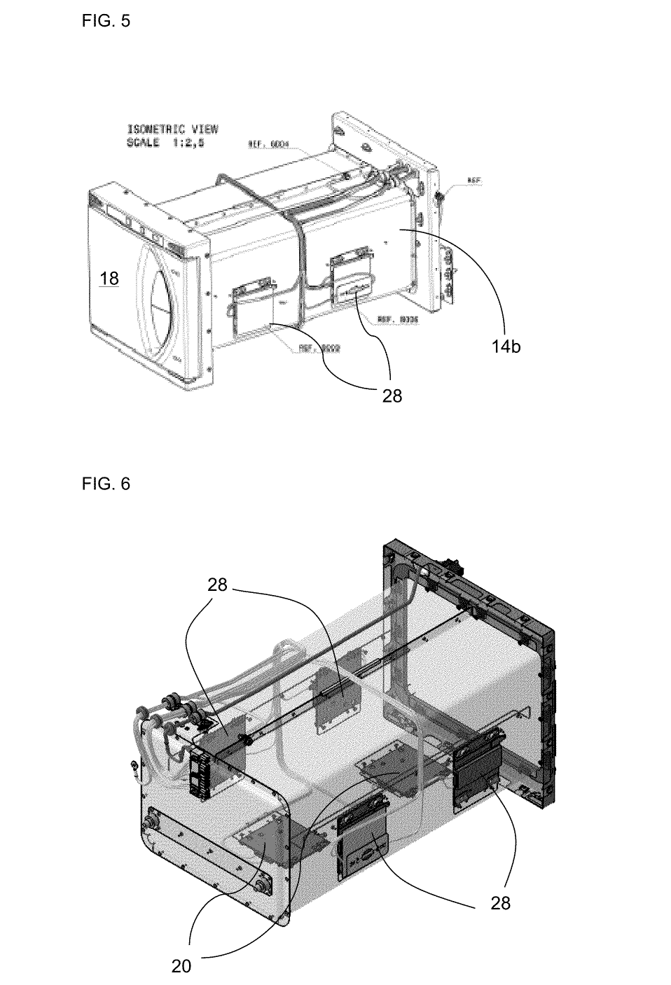

In one embodiment, an upper heating pad element 22 is positioned immediately behind the front door 18, along the top wall 24 of the device 10. The element 22 is positioned immediately adjacent to, and on top of, the top wall/liner 24. A schematic showing this configuration is provided in FIG. 4. Additionally or alternatively, device 10 may have side heater elements 28 positioned directly on the outer faces 14b of side walls 14. An illustration of what this embodiment may look like is shown in FIGS. 5 and 6. (FIGS. 5 and 6 actually illustrate the current warmer placement on bun warmers, but it should be understood that same or similar placements may be used in connection with the combination devices described herein.) Additionally or alternatively, FIG. 1 further illustrates that a back heater element 32 may be positioned along the outer face 15b of the back wall 15 and/or a top heater element may be positioned on the top wall.

It is possible to use one or more (or all) of the individual heater elements 22, 28, 32, depending upon the requirements of the device 10. For example, FIG. 6 shows two side heating elements 28 on each side of the device, as well as two heating elements 20 at the base of device. It is possible to provide the heating elements in any desired combination and/or location. In one embodiment, the individual heater elements are positioned as shown, but it is also possible to provide the heater elements as a large blanket that is generally wrapped around the walls of the cavity 12. Whatever form the heating elements take, there is generally a layer of insulation 34 provided around the one or more elements 20 in order to ensure that the outer housing of the cavity does not generate too much heat.

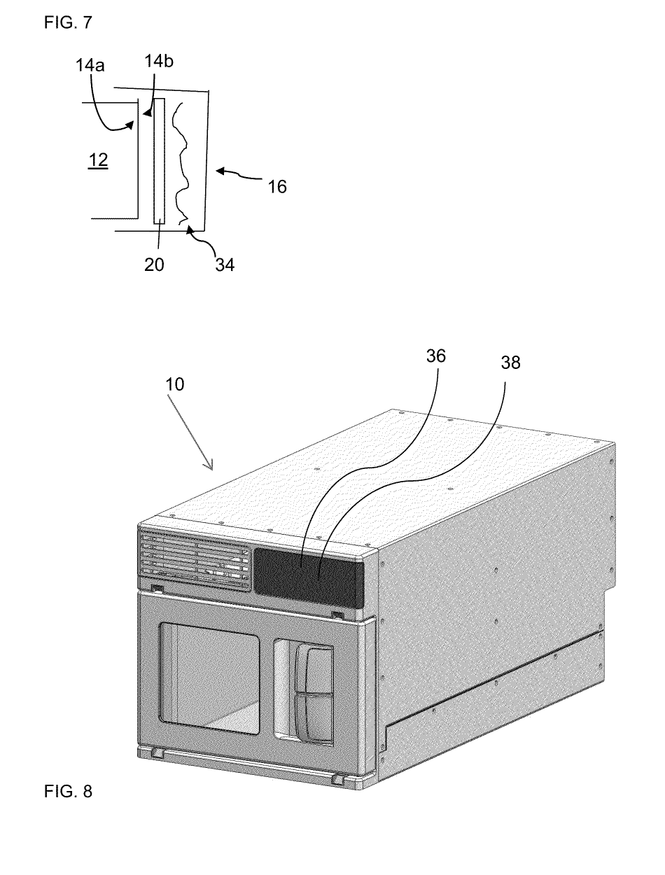

FIG. 7 shows a schematic of a side wall 14b of the cavity 12 with heating element 20 covered by insulation 34, and housed in outer housing 16. The insulation may be any appropriate type of high temperature insulation, such as fiberglass insulation or any other type of insulation that has been found useful with microwaves and/or ovens and/or heating systems. The outer housing 16 is typically an outer aluminum case.

The heater elements may be silicone resistive heaters, positive temperature controlled (PTC) heaters, or any other appropriate form of a heater than can be used to warm the stainless steel walls in order to generate and radiate heat. The heating elements may be flexible elements (e.g., silicone, polymers, or thick film) or they may be rigid elements that are mounted on the walls. If a resistive heater is used, an electric current is passed through a conductor to release heat. If a PTC heater is used, the heating element itself has self-regulating properties and self-limiting temperature characteristics. PTC heaters are small ceramic stones that have fast heating response times, and plateau once the pre-defined reference temperature is reached. The element serves as its own sensor, by increasing the wattage when used in colder temperatures and decreasing the wattage used as the temperature increased. The PTC self-regulates to a pre-set temperature and automatically varies its wattage in order to maintain that pre-set temperature. The rise in resistance stays within a fairly small temperature window of a few degrees centigrade. This has been found to result in a more efficient heating system in some instances. It is possible to form the stones into any desired shape, such as a square, rectangular, circular ring shaped, or any other shape that would fit this desired application. Above the reference temperature, the semiconducting and ferro-electrical properties of the ceramic produce a rise in resistance of several orders of magnitude, creating the self-limiting properties.

PTC heaters provide controlled electrical heat. It is envisioned that use of a PCT heating element eliminates the need for thermostatic controls by simplifying the design and providing reduced energy consumption. (The removal of failure-prone oven components such as thermostats can increase the reliability of the device, as well as increase the safety of its use, because no matter how much current is applied to the PTC, it will never surpass its intended surface temperature.)

Whichever type of heating element 20 is selected, however, the heater elements are installed in such a way that causes them to warm up the inner cavity 12 when bread (or any other items to be heated and/or warmed but not dried out) is put inside. They are generally intended to heat to just above 60° C. (or about 140° F.) such that food and/or bread may be warmed through. In some embodiments, the warmers heat up to about 70° C. It is understood however, that additionally or alternatively, the heater elements can be designed to generate more heat, such as higher heats that are sufficient for cooking food. It should also be understood that convection oven features may be added as well. Microwave ovens do not always heat uniformly, as they heat food from the inside out. They also do not brown food or make it crispy. If the heat levels delivered by the heating elements are significantly increased, the device may function as a combination microwave/convection oven/warmer, depending upon the setting selected. It may operate via natural convection or forced convection.

In use, the device 10 may switch between the desired settings. A digital keypad 36 and screen 38 are provided, as shown in FIG. 8, which allows the user to select the desired cooking and/or heating method. When the user selects the bun warmer option, the microwave magnetron is disabled and the heating elements heat up, and the conducted heat goes thru the inner liner and heats up the cavity 32. If the user selects microwave mode, the magnetron is activated and the heating elements are disabled.

One challenge experienced when converting between microwave use and warming use is that of managing air flow. When used as a warmer or cooking chamber, it is desirable that device 10 be sealed and air tight in order to keep the radiant heat inside the cavity 12. When used as a microwave, it is desirable that device 10 be vented, because air is blown over the magnetron and heat must be extracted out the back. Accordingly, the device 10 includes a gate valve which can either be opened to extract air or closed to maintain the radiant heat in the cooking cavity 12. Gate valve may be a check valve, an actuated valve (such as a valve actuated by a solenoid), a side lever that is manually actuated, or any other appropriate design. It is generally preferred that gate valve be automatically actuated, depending upon which type of cook/warm cycle is selected for use. Providing a gate valve allows optimization of airflow in order to accommodate with microwave or bun warming functions.

Although embodiments of the invention are described with respect to commercial aircraft, it should be understood that they may be used in any other instances where space and weight are sought to be optimized, including but not limited to private planes, yachts, cruise ships and other sea-going vessels, as well as motor homes, passenger trains, and any other passenger transport vehicles where quality food is sought to be prepared and served.

Changes and modifications, additions and deletions may be made to the structures and methods recited above and shown in the drawings without departing from the scope or spirit of the invention and the following claims.

What is claimed is:

1. A combination microwave and bun warmer device for use on board an aircraft, comprising:
(a) an inner cook cavity surrounded by side walls, a back wall, a top wall, a base, and a door;
(b) a magnetron associated with the cook cavity that generates microwaves;
(c) one or more heating elements positioned along outer faces of one or more of the side walls, the back wall, the top wall, or the base;
wherein the magnetron is activated for use of the device as a microwave oven in a first mode, and wherein the one or more heating elements are activated for use of the device as a bun warmer in a second mode.

2. The device of claim 1, wherein the one or more heating elements is a resistive heater.

3. The device of claim 1, wherein the one or more heating elements is a positive temperature control heater.

4. The device of claim 1, further comprising a gate valve that allows venting when the first microwave mode is used and that does not allow venting when the second warming mode is used.

5. The device of claim 1, wherein the one or more heating elements are positioned on the outer side walls, on the top wall, and on the back wall.

6. The device of claim 1, wherein the one or more heating elements are configured to generate up to about 70° C. such that food and/or bread may be warmed through.

7. The device of claim 1, installed in the galley of an aircraft.
